(19) United States
(12) Patent Application Publication
(10) Pub. No.: US 2008/0218486 A1
(43) Pub. Date: Sep. 11, 2008

(54) Contextual Touch Panel

(76) Inventors: Todd Haseyama, Encinitas, CA (US); Christopher L. Whittall, La Jolla, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/684,057

(22) Filed: Mar. 9, 2007

(51) Int. Cl. G06F 3/041

(52) U.S. Cl. 345/173

(57) ABSTRACT

In one embodiment, a touch panel for an electronic device includes: an electronic display; a frame bordering the display, the frame including a plurality of icons each representing a device control and wherein any icon representing a control that is available for a device function appearing on the display is highlighted and any icon representing a control that is not available for a device function appearing on the display is not highlighted; and a touch sensitive material for selectively activating device controls appearing on the display and for selectively activating highlighted icons.

### BACKGROUND

In some printers and other electronic devices a touch sensitive material overlaying a liquid crystal display (LCD) allows the user to selectively activate device controls that appear on the LCD by touching the overlay material. In some electronic devices that utilize such a touch panel, the LCD is one of the more expensive parts of the device. This is particularly true for photo printers that allow the user to edit and otherwise manipulate digital images that appear on the printer LCD.

### DRAWINGS

FIG. 1 illustrates one embodiment of a new touch panel, adapted for use as part of a photo printer, in an edit photo mode.

FIG. 2 is an exploded view of the touch panel of FIG. 1 in a thumbnail view mode.

FIG. 3 illustrates the icon frame bordering the LCD in the touch panel of FIG. 1.

FIG. 4 illustrates the touch panel of FIG. 1 in a slide show mode.

FIG. 5 illustrates the touch panel of FIG. 1 in a crop photo mode.

FIG. 6 illustrates the touch panel of FIG. 1 in a printer error mode.

FIG. 7 is a block diagram illustrating a printer that includes a touch panel such as the touch panel shown in FIG. 1.

### DETAILED DESCRIPTION

Embodiments of the new touch panel were developed in an effort to maximize the size of the touch panel in a photo printer; not limiting the area of the touch panel solely to the area described by dimensions of the LCD. The new panel has the advantage of allowing the user touch interaction area to expand beyond the bounds of the LCD. Embodiments of the new touch panel will be described with reference to a touch panel for a photo printer that allows the user to edit and otherwise manipulate digital images that appear on the printer display. Embodiments of the new touch panel, however, are not limited to use in photo printers, but may be used in other electronic devices as well.

As used in this document “touch panel” refers to the touch sensitive portion of the user interface and “touch panel display” refers to only the “electronic display” (or simply “display”) portion of the touch panel. An “electronic display” means a display on which images, including device control graphics, are displayed dynamically. An LCD is one example of an electronic display.

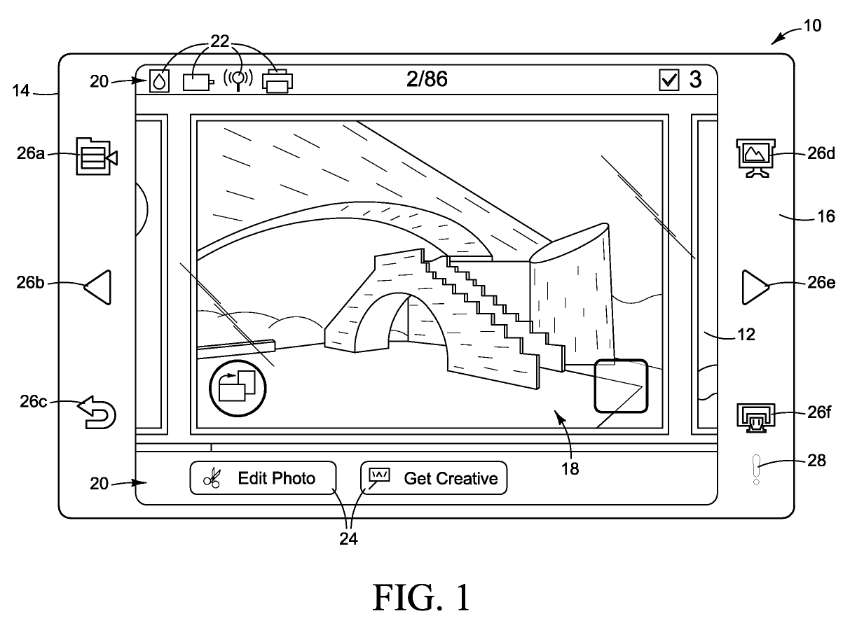

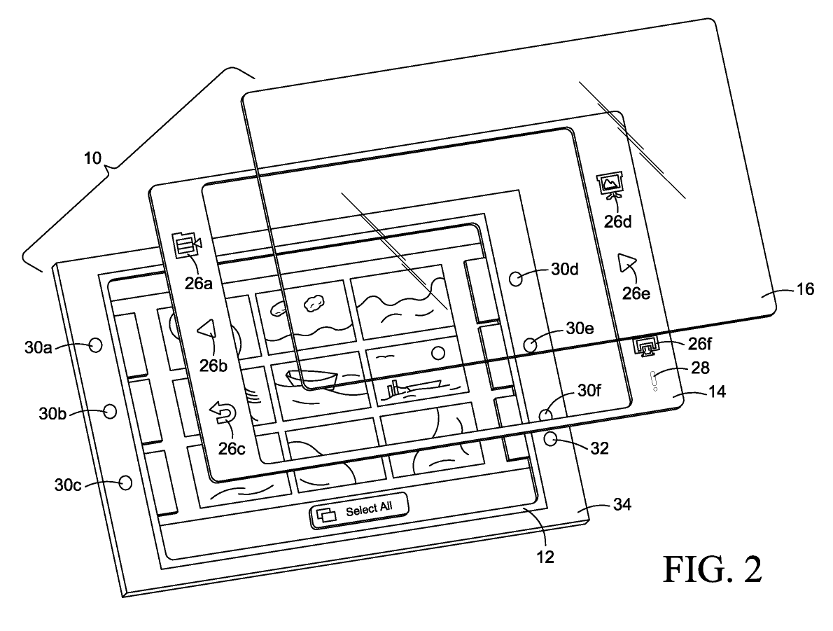

FIG. 1 illustrates a new touch panel 10 adapted for use as part of a photo printer. FIG. 2 is an exploded view of touch panel 10. FIG. 1 shows touch panel 10 in an edit photo mode and FIG. 2 shows touch panel 10 in a thumbnail view mode, such as might be available on a photo printer that allows the user to edit and otherwise manipulate digital images that appear on the printer display. Referring to FIGS. 1 and 2, touch panel 10 includes an electronic display 12, a frame 14 bordering display 12, and a touch sensitive material 16 overlaying display 12 and frame 14. Touch sensitive material 16 is also referred to as a touch screen 16. The visible area of display 12 includes image graphics 18 as well as device control function graphics 20 typical of a conventional graphical user interface. Device control functions 20 may include, for example, icons 22 and buttons 24 that may be selected by the user touching touch screen 16 in the vicinity of an icon 22 or button 24. Other areas of display 12 may also be active. Electronic display 12 may utilize any suitable display technology. For example, display 12 may be implemented as an LCD. Touch screen 16 may utilize any suitable touch screen technology. For example, touch screen 16 may be implemented as a resistive type screen that is activated by touching with a finger or a stylus.

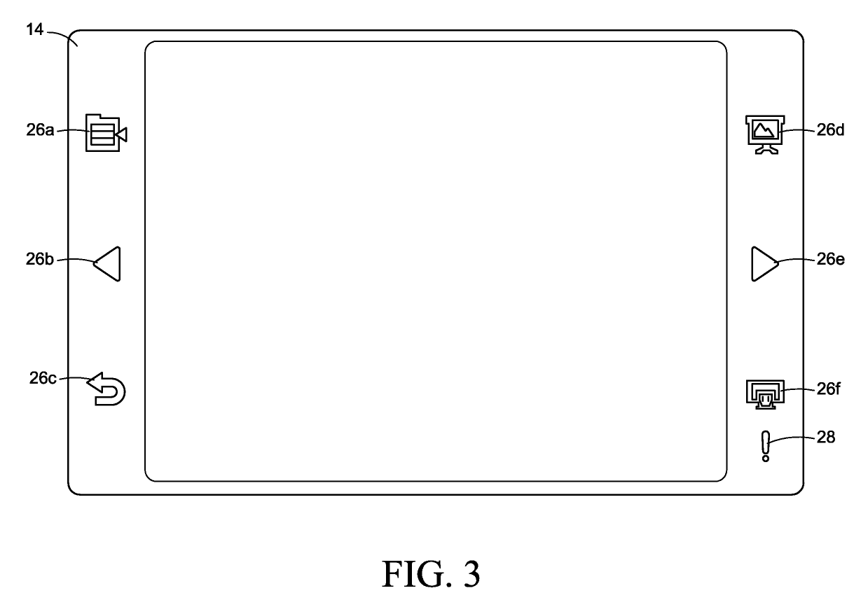

Referring now also to FIG. 3, frame 14 includes icons 26a-26f and 28 arranged along the sides of display 12. Frame 14 borders the full perimeter of display 12 but icons 26a-26f and 28 are located along only the two sides of the rectangular display 12. Other arrangements are possible. Factors affecting the arrangement of the frame icons include the type of device with which the touch panel is used, the functions and features of the device, the number and size of the frame icons, and the desired appearance and overall footprint for the touch panel. Each icon 26a-26f and 28 may be formed, for example, as a cut-out or other suitable transparency of the desired shape in an otherwise opaque framing material. Each icon 26a-26f and 28 is selectively illuminated by a corresponding lamp 30a-30f and 32. Each lamp 30a-30f and 32 may be implemented, for example, as a light emitting diode (LED).

In the embodiment shown, lamps 30a-30f and 32 are mounted in or otherwise surrounded by a background 34 that is the same color as frame 14. This matching background color scheme makes frame icons 26a-26f and 28 more difficult to see when not illuminated. Transparent icons 26a-26f and 28 in a black frame 14, for example, are virtually invisible against a black background 34 when not illuminated. Frame 14 may be formed from a flexible material, mylar for example, when supported by a structurally stable background 34 or other suitable supporting feature.

Each lamp 30a-30f is selectively energized to illuminate only those icons 26a-26f that are active for the particular feature presented on display 12. If an icon 26a-26f is not active (i.e., the area of touch screen 16 over the icon is not active), then the corresponding lamp 30a-30f is off. If an icon 26a-26f is active (i.e., the area of touch screen 16 over the icon is active), then the corresponding lamp 30a-30f is on. Frame icon 28 is an error indicator. Lamp 32 corresponding to frame icon 28 is energized in response to one or more device errors to illuminate icon 28 and thereby help alert the user to the error. A blinking lamp 32 intermittently illuminating error icon 28 may be used to help draw the user's attention to the error. Also, the seriousness of the error may be reflected in the color of a blinking lamp 32. For example, lamp 32 might blink yellow for a less serious error and red for a more serious error.

In the selective illumination scheme described above, frame 14 acts much like a graphical user interface presented on display 12 in which icons and buttons appear only when they are active. Frame 14 appears to the user as a part of or extension to display 12. This scheme makes it easier for the user to determine which functions are active for the particular feature presented on display 12 but without the cost of adding to the area of electronic display 12. For device controls that have a variable degree of activity, the illumination of the frame icon representing such a variable control may also be made to vary according to any variation in the control. For example, the speed of scrolling for a scroll control may vary according to the duration of time the user activates the control, by touching the representative icon 26(b) (scroll left) or 26(e) (scroll right) in FIG. 1. For this variable scroll control, scrolling left for example by touching icon 26(b), the intensity or color of lamp 30(b) may change to reflect the changing rate of scrolling. Alternatively, if lamp 30(b) blinks when icon 26(b) is touched, then the rate of blinking may change to reflect the changing rate of scrolling.

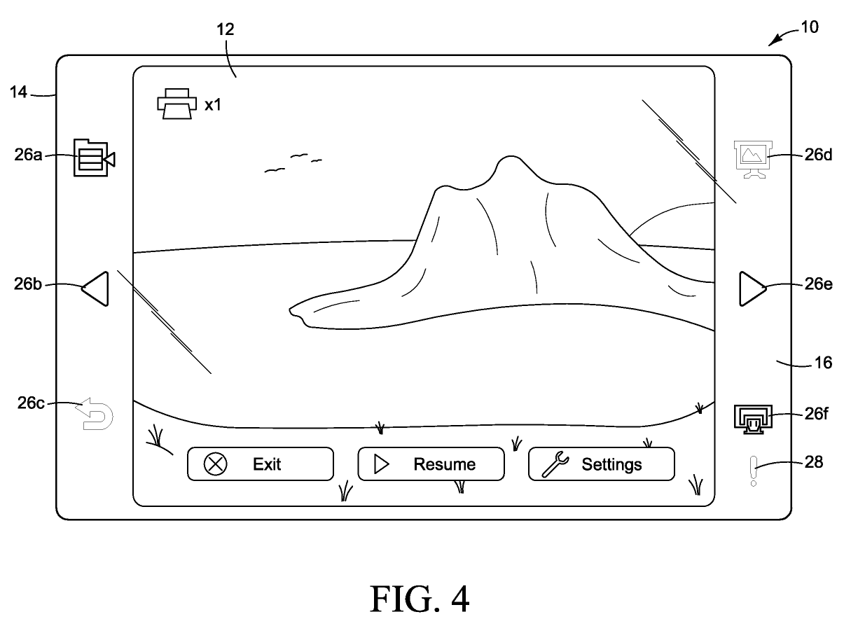

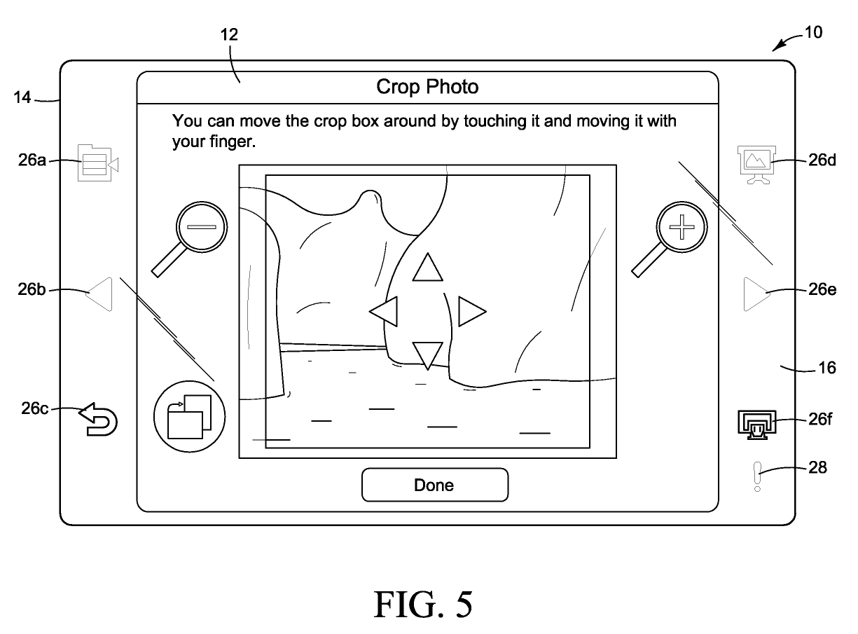

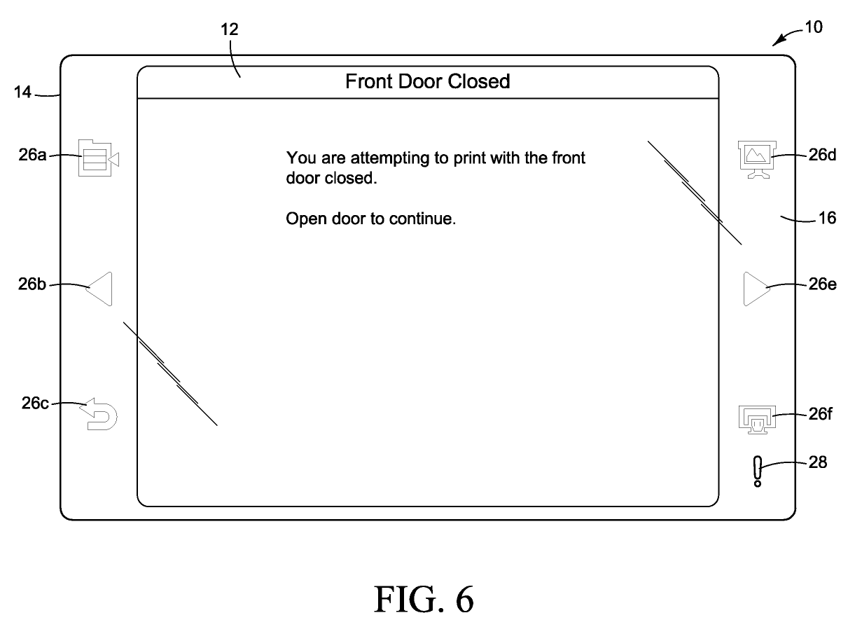

In the figures, a heavier line weight indicates a lamp is on and an icon is illuminated, while a lighter line weight indicates a lamp is not on and an icon is not illuminated. In FIG. 1, for example, frame icons 26a-26f are all active for the edit photo features presented on display 12 and, therefore, each lamp 30a-30f is on to illuminate each icon 26a-26f. Similarly, in FIG. 2, frame icons 26a-26f are all active for the thumbnail view features presented on display 12 and, therefore, each lamp 30a-30f is on to illuminate each icon 26a-26f. There are no device errors presented on display 12 in either FIG. 1 or FIG. 2 and, therefore, error lamp 32 is off and error icon 28 is not illuminated. By contrast, in FIG. 4 “go back” icon 26c and “slideshow” icon 26d are not active in the slide show features presented on display 12. Consequently, lamps 30c and 30d are off and icons 26c and 26d are not illuminated. FIGS. 5 and 6 illustrate other illumination scenarios. In FIG. 5, only “go back” icon 26c and “print” icon 26f are active for the crop photo feature presented on display 12 and, therefore, only lamps 30c and 30f are on to illuminate icons 26c and 26f. In FIG. 6, “error” icon 28 is illuminated by lamp 32 to indicate the error presented on display 12.

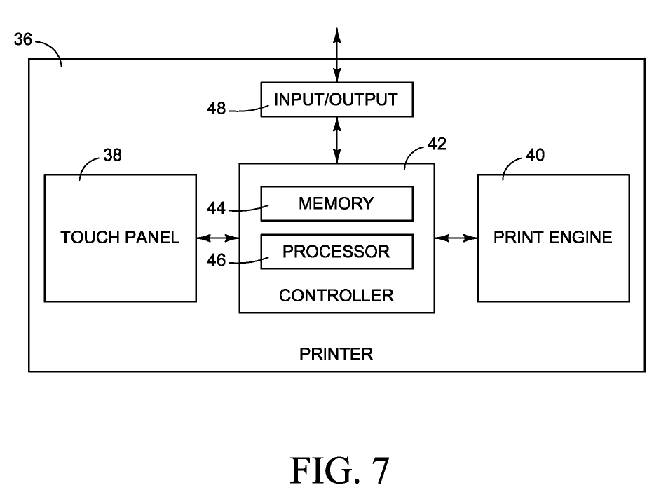

FIG. 7 illustrates a printer 36 that includes a touch panel 38, such as touch panel 10 shown in FIGS. 1 and 2. Referring to FIG. 7, printer 36 includes touch panel 38 and a print engine 40 operating under the control of an electronic controller 42. Controller 42 includes a memory 44 and a processor 46. Memory 44 may include a so-called “hard drive”, read only memory (ROM), and random access memory (RAM) for storing data and programming associated with all aspects of printer 36. Printer 36 also includes an input/output device 48 that allows printer 36 to communicate with host computers, other external devices and/or memory modules. While only a single controller 42 is shown, controller 42 may have constituent parts physically and/or logically associated with each of the touch panel 38, print engine 40, and/or input/output device 48. Similarly, input/output device 46 may include multiple devices depending on the functions of printer 36.

Print engine 40, controller 42 and input/output 48 represent well known printer components that may be readily adapted to the new touch panel. For a touch panel 10 from FIGS. 1 and 2 implemented in a photo printer 36 as printer touch panel 38 in FIG. 7, controller 42 will include application programming that allows the user to edit and otherwise manipulate digital images that appear on touch panel display 12. Controller 42 will also be configured to present control functions through the graphical user interface (GUI) presented on display 12 and through the icons on frame 14, as described above with reference to FIGS. 1-6. While it is expected that controller 42 will usually be configured to provide this functionality through the printer firmware, such functionality may be provided by any suitable printer programming.

The present invention has been shown and described with reference to the foregoing exemplary embodiments. It is to be understood, however, that other forms, details and embodiments may be made without departing from the spirit and scope of the invention which is defined in the following claims.

What is claimed is:

1. A touch panel for an electronic device, comprising:
an electronic display;
a frame bordering the display, the frame including a plurality of icons each representing a device control and wherein any icon representing a control that is available for a device function appearing on the display is highlighted and any icon representing a control that is not available for a device function appearing on the display is not highlighted; and
a touch sensitive material for selectively activating device controls appearing on the display and for selectively activating highlighted icons.

2. The touch panel of claim 1, wherein the frame comprises an opaque frame and each icon comprises a transparency in the frame and the touch panel further comprises a plurality of lamps each located near an icon to illuminate and thereby highlight the icon when the lamp is energized.

3. The touch panel of claim 1, wherein the touch sensitive material comprises a touch sensitive material overlaying the display and the frame.

4. The touch panel of claim 1, wherein the frame surrounds the display.

5. The touch panel of claim 1, wherein the frame comprises a colored opaque frame having transparent icons formed therein and the touch panel further comprises:
a colored background behind the icons, the background having the same color as the frame; and
a plurality of lamps each located within the background near an icon to illuminate and thereby highlight the icon when the lamp is energized.

6. The touch panel of claim 2, wherein the illumination of any icon representing a variable control will vary according to the variation in the control.

7. The touch panel of claim 6, wherein the illumination of any icon representing a variable control will vary in intensity and/or color according to the variation in the control.

8. The touch panel of claim 1, wherein the frame also includes an error icon representing an error condition in the device, the error icon being highlighted when the device experiences the error condition.

9. The touch panel of claim 8, wherein the frame comprises an opaque frame and the error icon comprises a transparency in the frame and the touch panel further comprises a lamp located near the error icon to illuminate and thereby highlight the error icon when the lamp is energized.

10. The touch panel of claim 9, wherein the lamp blinks to highlight the error icon.

11. A touch panel for an electronic device, comprising:
an electronic display;
a plurality of icons bordering the display, each icon representing a device control;
a plurality of lamps each located near a corresponding icon to illuminate the icon when the lamp is energized, each lamp operative to illuminate the corresponding icon only when the device control represented by that icon is active; and
a touch screen overlaying the display and the icons for selecting a device control appearing on the display and for selecting a device control represented by an illuminated icon.

12. The touch panel of claim 11, further comprising a background to the icons, the background configured to hide an icon when the icon is not illuminated.

13. The touch panel of claim 11, further comprising a frame bordering the display, each icon comprising a transparency in the frame.

14. The touch panel of claim 13, further comprising a background to the icons, each lamp disposed within the background and the background and the frame having the same color.

15. The touch panel of claim 14, wherein the frame comprises a black frame and the background comprises a black background.

16. The touch panel of claim 12, wherein a lamp is operative to vary the intensity, the color, and/or the duration of illumination of the icon corresponding the lamp based on a duration that a user touches a part of the touch screen active for the icon.

17. A printer, comprising:
a touch panel including an electronic display, a frame bordering the display, the frame having a plurality of icons each representing a printer control, and a touch sensitive material overlaying the display and the frame;
a print engine;
an input/output device; and
an electronic controller operatively connected to the touch panel, the print engine and the input/output device for controlling operation of the touch panel, print engine and input/output device, the controller operative to highlight any icon representing a control that is available for a printer function appearing on the display and to not highlight any icon representing a control that is not available for a printer function appearing on the display.

18. The printer of claim 16, wherein the frame comprises an opaque frame and each icon comprises a transparency in the frame and the touch panel also includes a plurality of lamps each located near an icon, the controller operative to illuminate and thereby highlight an icon by energizing the corresponding lamp.

19. The printer of claim 17, wherein the frame comprises a colored opaque frame having transparent icons formed therein and the touch panel also includes a colored background behind the icons, the background having the same color as the frame and each lamp located within the background.

20. The printer of claim 17, wherein the illumination of any icon representing a variable control will vary according to the variation in the control.

21. The printer of claim 16, wherein the frame also includes an error icon representing an error condition in the printer, the error icon being highlighted when the printer experiences the error condition.
